(19) United States
(12) Patent Application Publication
(10) Pub. No.: US 2004/0056862 A1
(43) Pub. Date: Mar. 25, 2004

(54) Method and apparatus facilitating adaptation of an entity to an information-based economy

(76) Inventor: Daniel I. Swedberg, Haymarket, VA (US)

Correspondence Address: David G. Wille, Esq., Baker Botts L.L.P., Suite 600, 2001 Ross Avenue, Dallas, TX, 75201-2980, US

(21) Appl. No.: 10/255,771

(22) Filed: Sep. 25, 2002

(51) Int. Cl. G06T 11/20

(52) U.S. Cl. 345/440

(57) ABSTRACT

A method involves generating ideas, providing a workspace divided into multiple sections that each correspond to a respective different category, assigning each idea to a respective category to which that idea is perceived to be most relevant, and associating each idea with a respective physical identifier. Each identifier is positioned within the workspace section corresponding to the assigned category for the associated idea, at a physical position which, in relation to other workspace sections, is representative of the perceived relevance of the idea to the categories associated with the other sections. The workspace and identifiers are part of an apparatus that can be used to carry out the method.

### STATEMENT REGARDING COPYRIGHT RIGHTS

A portion of this patent disclosure is material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

This invention relates in general to techniques for helping businesses and other entities adapt to changes and, more particularly, to techniques for helping entities adapt to changes that relate to the use of information-based technology and related opportunities.

### BACKGROUND OF THE INVENTION

A variety of different types of entities operate in a world economy which was traditionally based primarily on physical products and services. These entities include business entities (such as proprietorships, partnerships and corporations), government entities (such as cities, states, agencies and universities), non-profit organizations (such as foundations, churches and charities), and other types of entities. Each of these entities provides some form of value (such as a product or service) to persons or entities that are all referred to broadly here as customers.

In recent years, there has been a significant increase in the nature and types of information-based technology which is available to all of these entities. One example is the proliferation of the Internet. In the specific context of business entities, it can be said that the traditional economy, which is based primarily on physical products and services, has given way to some extent to an information-based economy. The information-based economy is also sometimes referred to as the “digital” economy. Consequently, all of the types of entities discussed above have an opportunity to utilize information-based technology to improve their operations, and their offerings (such as products and/or services). However, it is sometimes difficult for the persons in charge of these entities to identify appropriate ways in which to take advantage of new information-based technologies that are enabling the growth of the information-based economy.

### SUMMARY OF THE INVENTION

From the foregoing, it may be appreciated that a need has arisen for more effective techniques for helping an entity improve the offerings that it provides to the persons or entities it serves. According to the present invention, a method is provided to address this need, and involves: generating a plurality of ideas; providing a workspace which is divided into a plurality of sections that each correspond to a respective one of a plurality of different categories; assigning each idea to a respective category to which that idea is perceived to be most relevant; associating each idea with a respective one of a plurality of physical identifiers; positioning the identifier associated with each idea within the section of the workspace which corresponds to the assigned category for that idea, at a location selected so that the physical position of the identifier in relation to the other sections is representative of the perceived relevance of the associated idea to the respective categories associated with those other sections; classifying the identifiers into at least one initiative, where each initiative includes at least one identifier; subdividing the workspace into a plurality of priority regions; assigning an order of prioritization to the priority regions; and assigning priorities to the initiatives as a function of the physical location of each initiative with respect to the priority regions.

According to a different form of the invention, an apparatus includes: a workspace divided into a plurality of sections that each correspond to a respective one of a plurality of different categories, and separately divided into a plurality of priority regions which have an order of prioritization; a plurality of identifiers, the identifiers each being associated with a respective one of a plurality of ideas that are each assigned to one of a plurality of categories, and the identifiers each being positioned within a respective section of the workspace which corresponds to the assigned category for the idea associated with that identifier, at a location selected so that the physical position of each identifier in relation to the other sections of the workspace is representative of a perceived relevance of the associated idea to the respective categories associated with those other sections; and a plurality of indicators within the workspace which each represent a respective initiative and which each include at least one identifier, the initiatives being prioritized as a function of the physical location of each initiative with respect to the priority regions.

### BRIEF DESCRIPTION OF THE DRAWINGS

A better understanding of the present invention will be realized from the detailed description which follows, taken in conjunction with the accompanying drawings, in which:

FIG. 1 is a high-level flowchart showing a sequence that represents one form of a method which embodies aspects of the present invention;

FIG. 2 is a diagram of a planar and rectangular workspace which is used to carry out the method of FIG. 1;

FIG. 3 a further diagram of the workspace of FIG. 2, showing the workspace divided into exemplary priority regions;

FIG. 4 is another diagram of the workspace of FIG. 2, and shows a plurality of identifiers removably disposed within the workspace;

FIG. 5 is another diagram showing the workspace of FIG. 4, but with the addition of indicators identifying groups of identifiers that represent respective initiatives; and

FIG. 6 is a further diagram showing the workspace of FIG. 5, but with the priority regions of FIG. 3 superimposed on the workspace.

### DETAILED DESCRIPTION OF THE INVENTION

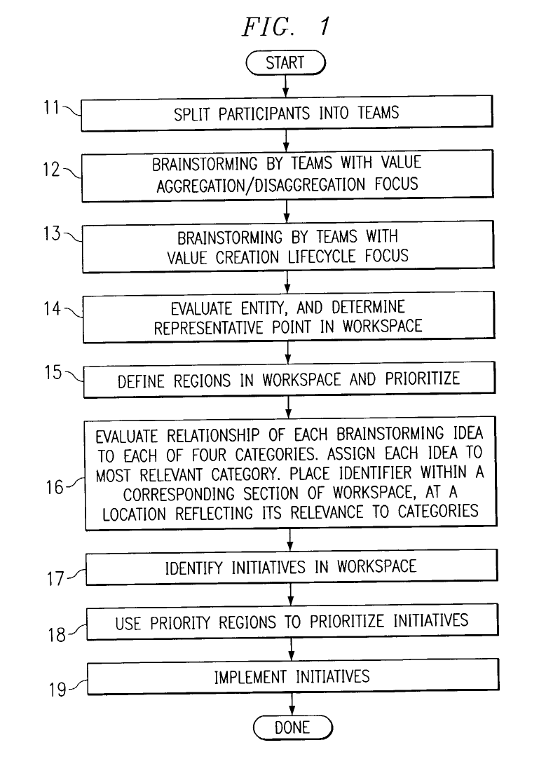

FIG. 1 is a high-level flowchart showing a sequence of blocks 11-19 that represent one embodiment of a method which embodies aspects of the present invention. The method shown in FIG. 1 is configured so that most of it can be carried out by the participants in a workshop or seminar. However, the method could alternatively be carried out in other contexts.

Before discussing the flowchart in detail, it is appropriate to provide some background information. As mentioned earlier, a variety of types of entities operate in a world economy which was traditionally based primarily on physical products and services. These entities include business entities (such as proprietorships, partnerships and corporations), government entities (such as cities, states, agencies and universities), non-profit organizations (such as foundations, churches and charities), and other types of entities. Each of these entities provides some form of value (such as a product or service) to persons or entities who are all referred to broadly here as customers.

In recent years, there has been a significant increase in the nature and types of information-based technology which is available to all of these entities. One example is the proliferation of the Internet. In the specific context of business entities, it can be said that the traditional economy based primarily on physical products and services has given way to some extent to an information-based economy, which is also sometimes referred to as the “digital” economy. Consequently, all of the types of entities discussed above have an opportunity to utilize information-based technology to improve their operations, and their offerings (such as products and/or services). However, it is sometimes difficult for the persons in charge of these entities to identify appropriate ways in which to take advantage of new information-based technologies that are enabling the growth of the information-based economy.

The flowchart of FIG. 1 depicts a methodology which helps persons involved with an entity to identify weaknesses in existing approaches, to identify ways in which to effectively use new technologies to address these weaknesses, and to prioritize various improvement initiatives for purposes of implementation. As noted above, the method depicted in FIG. 1 is configured so that most of it can be carried out in the context of a workshop or seminar. However, it should be understood that this method can alternatively be utilized in other contexts. In order to facilitate a clear understanding of the method depicted in FIG. 1, the portions of the method that can be carried out during a workshop will be explained below in the context of a hypothetical example of a typical workshop.

More specifically, for purposes of the discussion which follows, it is assumed that a workshop is to be conducted with a focus on a public sector entity such as a city or state, with the goal of generating several innovative initiates that will utilize information-based technologies to improve the value which the entity provides to its customers. A public sector entity has been intentionally selected for purposes of this example, in order to help emphasize that the disclosed method can benefit not only business entities, but also other types of entities. In this regard, it should be recognized that a public sector entity provides value to its customers (or in other words its constituents), for example through offerings such as police services, fresh water and/or waste disposal.

Many entities purchase information technology services from an outside provider. For purposes of the following discussion, it is assumed that the example workshop has twelve participants, where six of the participants are from the entity which is the focus of the workshop, and the other six are from the information technology services provider for that entity. The example workshop has been intentionally configured to utilize participants from two different organizations, in order to emphasize that the participants need not all be from the focal entity itself. The number of participants may be more than or less than twelve, and may be members of more than or less than two organizations. All or none of the participants may be from the focal entity itself.

Turning now in more detail of the flowchart of FIG. 1, the method begins in block 11, where the participants in the workshop are split into teams. For purposes of the example workshop discussed here, it is assumed that the twelve participants are split into two teams that each include six participants, where each team has three participants who are from the focal entity, and three participants who are from the information technology services provider for that entity. It will be recognized that the number of teams could be more than or less than two, and that there are a wide variety of ways in which the participants in the workshop could be allocated among multiple teams.

Next, at block 12, the teams each separately carry out a brainstorming session, using a conceptual tool which is referred to in this discussion as a value aggregation/disaggregation focus. This conceptual tool is known in the art, and is therefore described only briefly here, with reference to TABLE 1. In particular, prior to the brainstorming session, each team is given instructions consistent with those summarized in TABLE 1.

TABLE 1
BRAINSTORMING INSTRUCTIONS FOR
VALUE AGGREGATION/DISAGGREGATION FOCUS

| | |
|---|---|
| OVERVIEW | Identify opportunities to partner with |
| | others to improve value provided by |
| | entity. |
| SPECIFIC | Define who contributes at each level |
| STEPS | today, how they each contribute, and |
| | weaknesses perceived by customers. |
| | Identify opportunities to address each |
| | identified weakness through new |
| | partnerships among contributors, and |
| | express opportunities as a list of ideas. |

With reference to TABLE 1, each team is told that, as an overview, the purpose of the brainstorming session is to identify an opportunity for the entity which is the focus of the workshop to improve the value that it provides to its customers, through the approach of partnering with other entities. Then, each team is given specific steps to carry out during the brainstorming session. First, the team is told to identify the persons or entities who currently contribute at each level to the delivery by the entity of value to its customers. These persons or entities may be internal to the entity, or external to the entity. The teams are asked to then identify weaknesses perceived by customers of the entity with respect to the value that is provided, and/or the manner in which it is provided. Next, the participants are asked to identify ways in which each identified weakness can be addressed through new partnerships among the contributors, and to express these opportunities as a list of ideas. After receiving preliminary instructions consistent with TABLE 1, the teams meet separately and carry out the instructions of TABLE 1, resulting in the generation by each team of a first list of ideas.

Referring again to FIG. 1, the next segment of the method is represented by block 13, where the same teams separately carry out a second brainstorming session using a different conceptual tool, which is referred to here as a value creation lifecycle focus. This second conceptual tool is known in the art, and is therefore described only briefly here, with reference to TABLE 2. In particular, after the first brainstorming session and prior to the second brainstorming session, each team is given the instructions which are summarized in TABLE 2. With reference to TABLE 2, each team is told that, as an overview, the purpose of the second brainstorming session is identify opportunities for the focal entity to improve the value that it provides to customers through the technique of shifting existing processes to digital economy initiatives (which may also be referred to as virtual processes). Each team is then given specific steps to carry out.

TABLE 2
BRAINSTORMING INSTRUCTIONS
FOR VALUE CREATION LIFECYCLE FOCUS

| | |
|---|---|
| OVERVIEW | Identify opportunities to improve value |
| | of entity by shifting existing processes |
| | to digital economy initiatives. |
| SPECIFIC | Describe how each of six processes are |
| STEPS | conducted today, and identify issues |
| | perceived by customers as to each such |
| | process. |
| | Identify opportunities to address each |
| | identified weakness by providing virtual |
| | process interfaces, and express |
| | opportunities as a list of ideas. |

In particular, with reference to TABLE 2, each team is told to first discuss or describe how each of six processes are currently conducted, and to then identify issues or weaknesses perceived by customers as to each of these processes. The six processes are (1) “CREATE” (such as research and development), (2) “INFORM” (such as advertising or outreach), (3) “SUPPORT” (such as providing customer service), (4) “TRANSACTION” (such as selling or verifying eligibility for a service), (5) “FULFILLMENT” (such as the provision of a service), and (6) “CONSUMPTION” (involving what happens to a customer during use of the product or service). The goal of the brainstorming session is to identify ways that existing approaches in each of the six processes can be shifted to virtual processes. Still referring to TABLE 2, the next step for each team is to identify opportunities to address each identified weakness through the use of a virtual process interface, and to express these opportunities as a second list of ideas.

The conceptual tools discussed above in association with TABLEs 1-2 are merely examples of conceptual tools which can used for brainstorming sessions that are part of the method depicted in FIG. 1. It would be possible to use other types of conceptual tools, including other existing conceptual tools, as well as conceptual tools that may be developed in the future. Further, although the disclosed method uses two conceptual tools, it would be possible to use a larger or smaller number of conceptual tools.

Referring again to FIG. 1, when the two teams have each completed the two successive brainstorming sessions discussed above in association with blocks 12 and 13, each team will have first and second lists of ideas that were respectively generated during the two brainstorming sessions. Each team can then consolidate its two lists of ideas into a single list. In this regard, TABLE 3 is a consolidated list of the ideas developed by the first team from its two successive brainstorming sessions, and TABLE 4 is a consolidated list of the ideas developed by the second team from its two successive brainstorming sessions. The specific ideas presented in TABLEs 3 and 4 are merely exemplary ideas, and it will be recognized that the specific ideas generated during any specific workshop will be tailored to the specific entity which is the focus of the workshop, and will depend on the thinking processes of the particular individuals who are the participants in the workshop. The ideas listed in TABLE 3 will now be briefly described, for purposes of clarity.

TABLE 3
IDEAS FROM TEAM 1

| | |
|---|---|
| A | Include desktop management services. |
| B | Include education content partner to seed |
| | broadband network. |
| C | Provide converged network for data/voice using |
| | Internet. |
| D | Offer to bring other user traffic to the |
| | broadband network. |
| E | Partner with media firm to support consumer |
| | build-out objective. |
| F | Include business process re-engineering (BPR) |
| | services to help entity use broadband in its |
| | business. |
| G | Establish a joint economic development |
| | innovation program. (Go to market element |
| | taking to other markets). |

With reference to TABLE 3, Idea A is to outsource management of the entity's desktop computers to an outside entity, rather than handling this management internally. Idea B is to establish a relationship with an education content partner in order to seed a broadband network. In other words, it may be advantageous to the focal entity to have the benefits of a broadband network, but the focal entity may not initially have sufficient internal use for such a network to justify the cost of implementation and maintenance. By including an education content partner, such as a university, additional uses can be initiated. For example, educational information such as classroom instruction can be delivered from the university to employees of the focal entity, in order to help facilitate the goal of implementing a more robust and high performance network.

Idea C is to provide a converged network for data and voice using the Internet. One example of this is a known technology in which telephone traffic is routed through an intranet and/or the Internet using what is known as Internet Protocol (IP) telephony. Idea D is to offer to bring other user traffic to the broadband network. As one example, use of the broadband network could be leased to others in order to defray some of the costs, particularly during startup of the broadband network.

Idea E is to partner with a media firm in order to support a consumer build-out objective. As one example, the focal entity might enter into a cooperative relationship with a major provider of on-line services, in order to get consumers to use the new network so as to increase the amount of network traffic and thus help to defray the cost of the network. Idea F is to use business process re-engineering (BPR) services in order to help the focal entity to use broadband in its business, where the word “business” is used to refer not only to true business entities, but also to entities which are not true business entities. As one specific example of Idea F, consultants might be employed by the focal entity to help the focal entity use the network in the course of its activities. Idea G is to establish a joint economic development innovation program. For example, the focal entity might cooperate with other entities in a joint effort to promote development of still other entities that would use the network and potentially create new jobs.

Turning to TABLE 4, the ideas listed in TABLE 4 are also merely exemplary, but are briefly discussed here for purposes of clarity.

TABLE 4
IDEAS FROM TEAM 2

| | |
|---|---|
| H | Provide a performance dashboard capability/ |
| | client reporting of service provisions. |
| I | Performance dashboard as part of entity's |
| | management approach. |
| J | University collaboration on “over-the-horizon” |
| | technology. |
| K | Provide eRoom to support collaboration. |
| L | Support development of eRepresentative |
| | capability. |
| M | Acquire assets to adopt variable rather than |
| | fixed cost approach for all infrastructure |
| | (utility approach). |

In TABLE 4, Idea H is to provide a performance dashboard capability and/or client reporting of service provisions. In the context of a computer network, this might involve the provision of one network site which is accessible to a number of people and which provides a snapshot of how the focal entity is currently progressing in meeting its goals regarding the provision of value to its customers. This site might, for example, present information in the form of a multi-color display, such as a pie chart. Idea I is to provide a performance dashboard as part of the focal entity's management approach. This might, for example, involve an automated approach to viewing the progress of the focal entity in meeting its goals regarding the provision of value to its customers.

Idea J is to obtain university collaboration on “over-the-horizon” technology. This might, for example, involve cooperation between the focal entity and a university in carrying out research and development for beneficial future technology. Idea K is to provide a virtual project office or “eRoom” to support collaboration. This might, for example, involve a common virtual space or site in which documents and the like can be accessed by many persons.

Idea L is to support development of an “eRepresentative” capability. This might, for example, involve efforts to increase the extent to which elected state or federal legislators use the network to communicate with constituents. Idea M would be to acquire assets to adopt a variable rather than fixed-cost approach for all infrastructure. As one example, the entity might lease computer hardware or software from a pool or grid, rather than purchase the hardware or software.

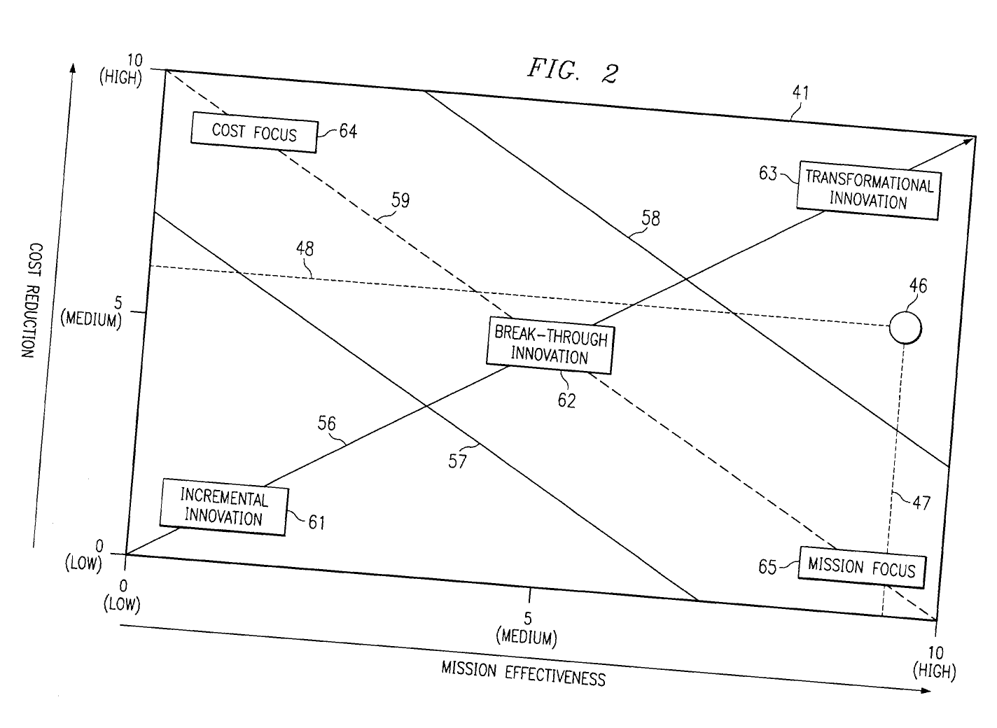

Referring again to FIG. 1, block 14 represents the next step in the process, where the participants in the workshop jointly evaluate the entity which is the focus of the workshop, and determine a representative point for that entity in a workspace. In the exemplary workshop described here, the participants are provided with FIG. 2, which is a diagram of a planar and rectangular workspace 41. Along the bottom of the workspace is a horizontal axis, which represents the importance to the entity of its effectiveness in carrying out its mission, on a scale from zero to ten. Stated differently, this relates to the interest of the focal entity in doing a better job of what it is doing. In the case of a business entity, the mission of the entity would typically be revenue generation. In the case of a government entity, the mission of the entity would typically be the delivery of services to its constituents. Along the left side of the workspace is a vertical axis, which represents the importance to the entity of cost reduction, on a scale from zero to ten.

In order to carry out the segment of the workshop represented by block 14, the participants in the workshop are asked to first characterize the environment of the focal entity in terms of what is important to the entity with respect to the two characteristics represented by the horizontal and vertical axis. Assume that, for purposes of the exemplary workshop discussed here, the participants rate the importance of increasing the effectiveness of the entity's mission at a value of 8 along the horizontal axis, and rate the importance to the entity of cost reduction at a value of 6 along the vertical axis. Based on these two values determined by the participants, a single corresponding point 46 is plotted within the workspace 41. In particular, and as evident from the broken lines 47 and 48, the location of the point 46 corresponds to a value of 8 along the horizontal axis, and a value of 6 along the vertical axis. It will be noted that the rectangular region to the left of the broken line 47 and below the broken line 48 represents a portion of the workspace 41 which is of value to the focal entity.

Referring again to FIG. 1, block 15 represents the next step in the sequence. In association with block 15, the participants in the workshop define regions within the workspace, and then prioritize them. In this regard, and referring again to FIG. 2, it will be noted that a solid line 56 extends diagonally from the lower left corner of the workspace to the upper right corner. The line 56 is intersected by two more solid lines 57 and 58, which are spaced and parallel to each other. It will be noted that the lines 57 and 58 are each approximately parallel to each other, and parallel to a broken line 59 which extends diagonally from the upper left corner to the lower right corner of the workspace. Further, the lines 57 and 58 are disposed on opposite sides of, and are each approximately the same distance from, the broken line 59.

The three solid lines 56-58 divide the workspace 41 into six regions that are used as a basis for assigning priorities, as discussed later. Moving along the line 56 from its lower left end to its upper right end represents a progression from incremental innovation at 61 through break-through innovation at 62 to transformational innovation at 63. A portion of the workspace near the upper left corner, between the lines 57 and 58, represents a strong focus on cost reduction, as indicated at 64. A portion of the workspace near the lower right corner, between the lines 57-58, represents a strong focus on the mission of the entity, as indicated at 65. Although the disclosed method uses three lines 56-58 which define a particular pattern of six regions, it would alternatively be possible to use a larger or smaller number of lines, a larger or smaller number of regions, and/or a different pattern of regions.

Once the participants in the workshop have plotted the point 46, in the manner described above, they are instructed to jointly utilize the position of the point 46 as a basis to define priority regions within the workspace 41 which are based fundamentally on the three lines 56-58, and to then jointly prioritize these priority regions. To facilitate this, the participants are told to give some emphasis to the rectangular portion of the workspace in the lower left corner of the workspace, which is bounded by the broken lines 47 and 48.

For the sake of example, assume that the participants of the exemplary workshop note that the two regions of the workspace above and to the right of the line 58 contain little or none of the rectangular portion of the workspace bounded by the lines 47-48, and decide to combine these two regions into a single priority region. Assume that the participants also note that the rectangular portion of the workspace bounded by lines 47-48 includes most or all of the two regions that are below and to the left of the line 57, and decide to combine these two regions into a single priority region.

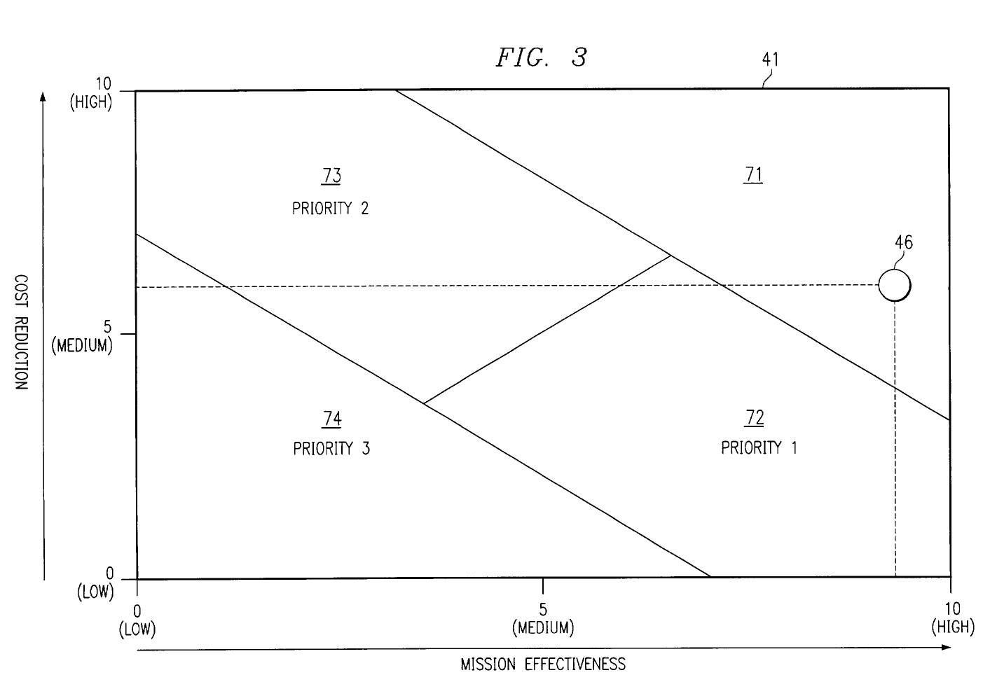

This results in four priority regions. More specifically, FIG. 3 is a further diagrammatic view of the workspace 41, which is similar to FIG. 2 but omits some of the detail of FIG. 2, and which shows at 71-74 the four priority regions defined by the participants in the workshop. As mentioned earlier, the workshop participants are next asked to assign priorities to each of the priority regions 71-74. Referring to FIGS. 2 and 3, the region 71 represents the greatest degree of innovation along both axes, but contains almost none of the rectangular portion of the workspace 41 which is defined by the point 46 and bounded by the lines 47-48. Accordingly, in the exemplary workshop, the participants decided to ignore the region 71 for purposes of priority, and did not assign it a priority. The participants could alternatively have assigned to region 71 the lowest level of priority.

The regions 72 and 73 each represent a medium degree of innovation. As to the rectangular portion of the workspace defined by the point 46 and bounded by lines 47-48, the part of this rectangular portion which is within the region 72 is at least twice as large as the part thereof which is within the region 73. Consequently, the participants in the exemplary workshop decided to define the region 72 as the Priority 1 region, and the region 73 as the “Priority 2” region. The region 74 lies almost entirely within the rectangular portion of the workspace which is defined by the point 46 and bounded by the lines 47-48, but the region 74 involves the least degree of innovation along both axes of the workspace. The participants in the exemplary workshop therefore decided to define the region 74 to be the “Priority 3” region.

As evident from the foregoing discussion, the definition of the priority regions shown in FIG. 3, and the prioritization of these regions, is dependent on the particular position determined for the point 46 by the participants in the workshop. In a different workshop, the point 46 could be plotted at a significantly different location within the workspace 41, which in turn could cause the definition of the priority regions as well as their prioritization to be significantly different, even where the participants start out with the same three lines 56-58.

Referring again to FIG. 1, block 16 represents the next step in the disclosed method, which begins by having the workshop participants jointly evaluate the relationship of each brainstorming idea to each of four categories. The first category is “Technology Innovation”. Examples of technology innovation include improvement in the effectiveness and/or efficiency of information capture, information processing, and/or information dissemination techniques that are supported by information technology. Other examples include utilization of new information technologies, employing technologies in new ways, and utilizing information technologies in ways that better meet applicable requirements. Use of the Internet to provide access to information is one specific example of technology innovation.

The second category is “Process Innovation”. Examples of process innovation include improvement in the processes within which information is used, as well as promoting a shift in the way work is done from a physical setting to a virtual setting. Other examples of process innovation include virtualization of new processes, and/or improvement in the convenience of processes. Improvement in the area of electronic commerce (e-commerce) is an example of process innovation.

The third category is “Offering Innovation”. Examples of offering innovation include increases in the value of services provided to customers by providing new information-based offerings and/or by improving the information content of existing offerings. One specific example of offering innovation is to provide call center operators with access to an increased amount of available data regarding customers of the entity.

The fourth category is “Business Model Innovation”. Examples of business model innovation include shifting the boundaries of the activities of the focal entity, typically by partnering and/or by outsourcing activities in order to share risk and/or shift investment costs. Business model innovation is typically the most encompassing area of innovation, and can be reflected in the business arrangements presented in proposals to customer.

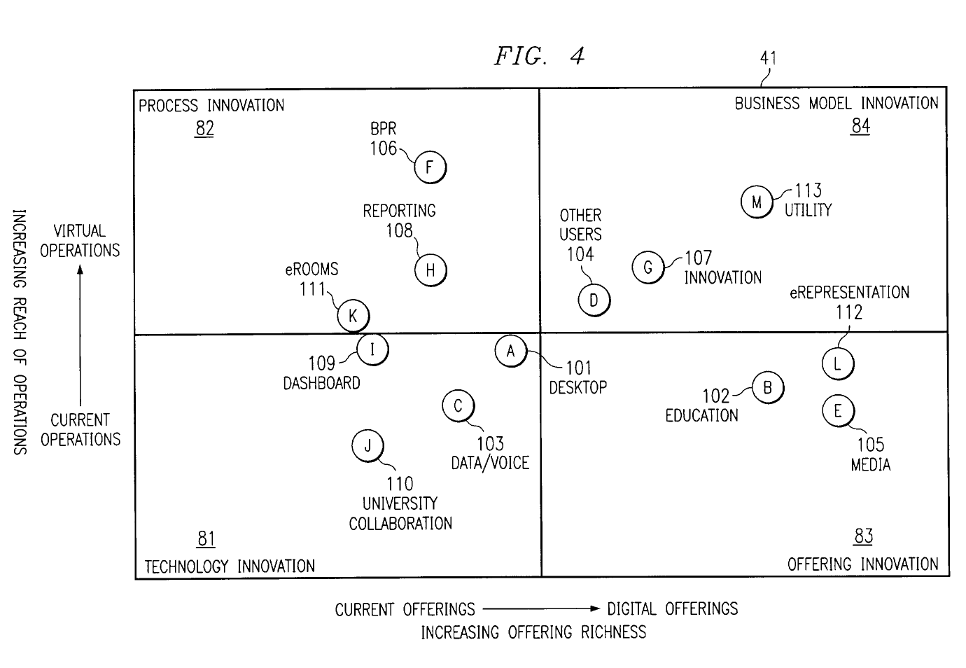

FIG. 4 is another diagram of the workspace 41 that has already been discussed above in association with FIGS. 2 and 3. FIG. 4 highlights two significant principles of digital economy innovation and the relationship of those principles to the four categories of innovation. The vertical and horizontal axes have different labels, so that workshop participants are not likely to immediately recognize that the workspace 41 in FIG. 4 is the same workspace 41 to which they were exposed in association with FIGS. 2-3. In particular, the vertical axis represents the operational reach of the focal entity, from current operations to virtual operations. The horizontal axis represents the richness of what the focal entity provides to its customers, from current offerings to digital or information-enhanced offerings.

In FIG. 4, the rectangular workspace 41 has been subdivided into four rectangular sections 81-84 of equal size, which are arranged in a two-by-two matrix. With reference to the horizontal and vertical axes of the workspace, the regions 81-84 each correspond to a respective one of four categories, as represented by the labels which are present in each of the sections 81-84 in FIG. 4. In particular, the section 81 corresponds to a “Technology Innovation” category, the section 82 corresponds to a “Process Innovation” category, the section 83 corresponds to an “Offering Innovation” category, and the section 84 corresponds to a “Business Model Innovation” category.

As mentioned above, block 16 of FIG. 1 begins with a request that the participants in the workshop jointly evaluate the relationship of each brainstorming idea (TABLEs 3 and 4) to each of the four categories. Still referring to block 16, the participants are then directed to assign each idea to the most relevant category, and place an identifier within one of the sections 81-84 of the workspace which corresponds to that category, at a location within that section reflecting the relevance of that idea to the other three categories. One technique for carrying this out is discussed below.

In the context of the exemplary workshop, a representation of the workspace 41 of FIG. 4 is provided on a wall, for example by sketching the workspace 41 in a large size on a whiteboard. Each of the ideas developed by the teams of participants is written on a separate self-adhesive sheet that serves as a respective identifier 101-113, and each of these self-adhesive sheets is then removably placed at the appropriate location in the workspace. One suitable type of self-adhesive sheets are the self-adhesive notes which ATTORNEY's DOCKET PATENT APPLICATION 014208.1544 are available under the trademark “POST-IT” from Minnesota Mining and Manufacturing Company (3M) of St. Paul, Minn.

The circular elements in FIG. 4 are a diagrammatic representation of thirteen identifiers 101-113 which respectively correspond to the thirteen ideas A-M in TABLEs 3-4. The locations of the identifiers 101-113 indicate where the participants in the exemplary workshop positioned the thirteen identifiers 101-113 within the workspace 41. A brief discussion of the placement of some selected identifiers will be helpful.

With reference to FIG. 4, the workshop participants evaluated Idea A from TABLE 3 with respect to each of the four categories discussed above, and concluded that it related most closely to the “Technology Innovation” category, but that Idea A was also relevant to one or more of the other three categories. Accordingly, the participants placed the self-adhesive note or identifier 101 for Idea A within the section 81 of the workspace which corresponds to the “Technology Innovation” category, but at a location where it would be physically close to the sections representing at least two other categories, and thus in the corner of the section 81 which is closest to each of the other sections 82-84.

There are different ways in which the participants may have arrived at this result for Idea A, because participants may or may not reach unanimous agreement as to the relevance of various categories with respect to any given idea. For example, following discussion and negotiation, the participants may have reached substantially a consensus as to the relevance of Idea A to each of two or three different categories. Alternatively, after discussion and negotiation, a majority of the participants may have felt that Idea A was most relevant to the “Technology Innovation” category, a first minority of participants may have felt that Idea A was most relevant to a second of the categories, and a second minority may have felt that Idea A was most relevant to yet a third category.

As another example, the participants determined that Idea I from TABLE 4 was most relevant to the “Technology Innovation” category, and was also fairly relevant to the “Process Innovation” category, but was not particularly relevant to either the “Offering Innovation” or the “Business Model Innovation” category. Consequently, the self-adhesive note or identifier 109 for Idea I was placed within the section 81 of the workspace 41 corresponding to the “Technology Innovation” category, at a location closely adjacent the section 82 corresponding to the “Process Innovation” category, but at a location spaced somewhat from each of the sections 83 and 84 that respectively correspond to the “Offering Innovation” and “Business Model Innovation” categories.

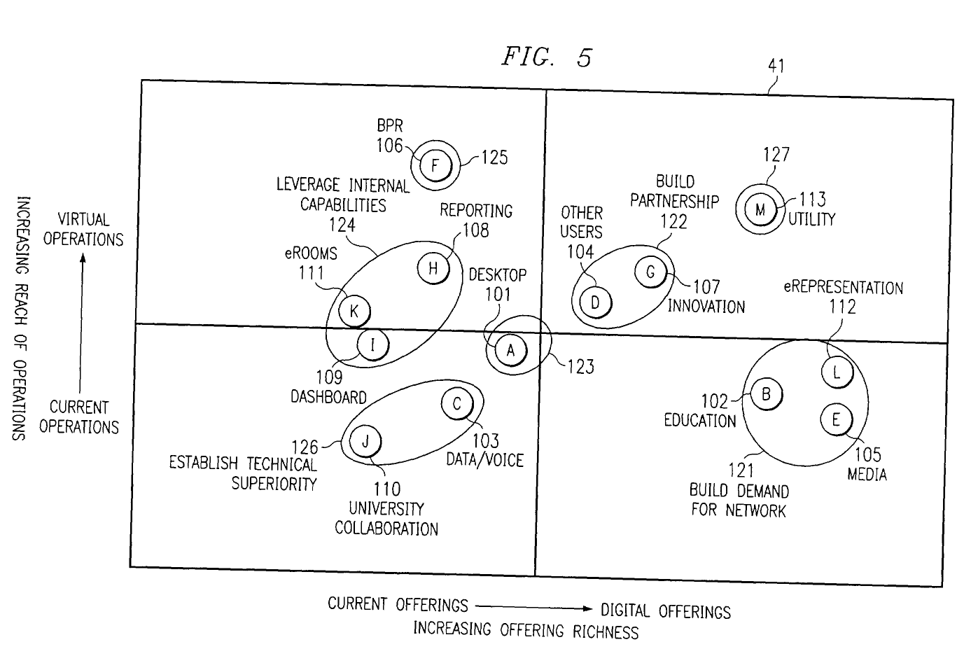

Referring again to FIG. 1, block 17 represents the next step in the disclosed method. In particular, in association with block 17, the participants in the workshop are asked to identify groups of one or more ideas within the workspace 41, where each such group is referred to as an initiative. FIG. 5 is a view of the workspace 41, which is identical to FIG. 4 except that workshop participants have identified seven initiatives 121-127. Each initiative in FIG. 5 is represented by a respective circle or oval drawn by the participants around the identifiers for one or more ideas. In this regard, if the workspace 41 is presented on a whiteboard in the manner discussed above, and if the ideas positioned within the workspace are on self-adhesive notes, each initiative can be identified by using a standard whiteboard marker to draw a circle around one or more ideas that represent a given initiative.

Where an initiative includes two or more ideas, they are ideas for which the associated identifiers are positioned relatively close to each other within the workspace 41, and which were determined by the participants to be conceptually related. It will be noted in FIG. 5 that the workshop participants have formulated and written a title near each of the four initiatives that contain two or more ideas, in order to reflect what the participants considered to be a common characteristic of these ideas. In particular, the initiative 121 has been titled “Build Demand for Network”, the initiative 122 has been titled “Build Partnership”, the initiative 124 has been titled “Leverage Internal Capabilities”, and the initiative 126 has been titled “Establish Technology Superiority”.

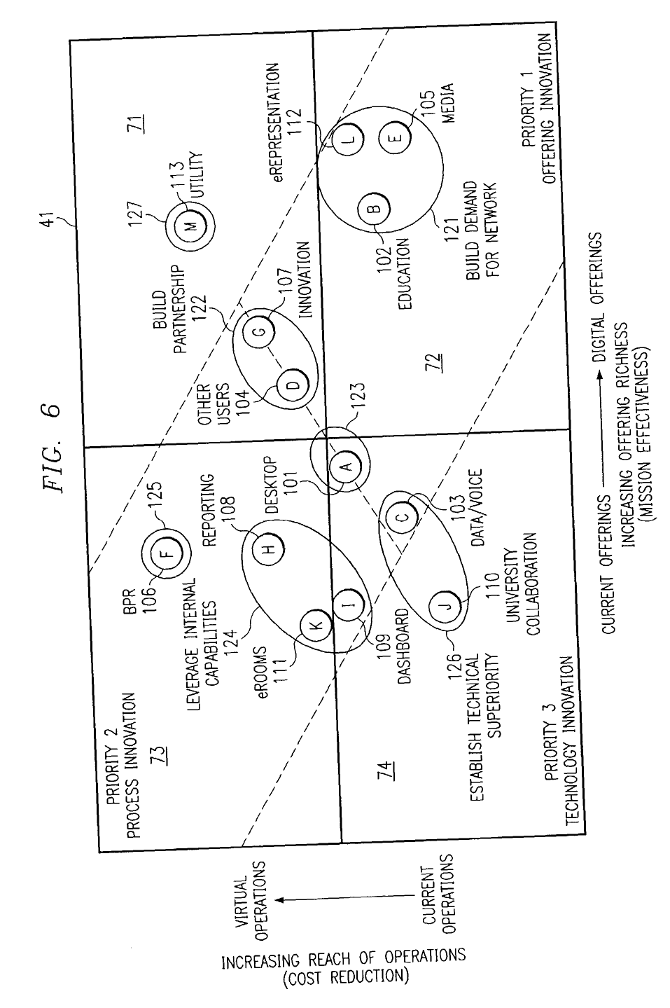

Referring to FIG. 1, block 18 represents the next step in the disclosed method. In association with block 18, the workshop participants are asked to overlay the priority regions defined in block 15 on the workspace shown in FIG. 5, and to then to prioritize the initiatives 121-127 that were identified in association with block 17. In this regard, FIG. 6 is a further diagram showing the workspace 41, and is identical to FIG. 5 except for the addition of the four priority regions 71-74 of FIG. 3. The initiatives are then prioritized by the workshop participants, as a function of the positions of the initiatives with respect to the priority regions.

In the example workshop, the participants assigned the highest priority to initiative 121, because the three identifiers 102, 105 and 112 within this initiative are all contained within the “Priority 1” region 72 that has the highest priority. The initiative 122 was assigned the second level of priority, and the initiative 123 was given the third level of priority, because each of the identifiers 101, 104, and 107 in initiatives 122 and 123 were at least partly within the “Priority 1” region 72.

The fourth level of priority was assigned to initiative 124, because the three identifiers 108, 109 and 111 in this initiative were all within the “Priority 2” region 73. The fifth level of priority was assigned to initiative 125, because the single identifier 106 in this initiative was within the “Priority 2” region 73. The sixth level of priority was assigned to initiative 126, because one of the identifiers 110 in this initiative was in the “Priority 3” region 74. The workshop participants did not assign a priority level to initiative 127, because the sole identifier 113 in this initiative was entirely within the priority region 71 and, as discussed above, the participants did not assign the region 71 any priority level. In this regard, and as discussed above, the workshop participants decided that the region 71 involved subject matter of little interest to the focal entity, because of the positions of the point 46 and the lines 47 and 48 in FIG. 2. However, the participants could alternatively have assigned the initiative 127 the seventh and lowest level of priority.

Referring again to FIG. 1, block 19 represents the last step in the disclosed embodiment of the method, which is the only illustrated step that would typically not be carried out in the context of a workshop, but instead would be carried out over a period of time following the workshop. In more detail, the initiatives 121-127 have been identified and prioritized during the workshop, as discussed above. After the workshop, the focal entity can take steps to implement at least some of these initiatives.

For example, the focal entity may not have the resources needed to immediately pursue all of the initiatives identified in the workshop, and would therefore pursue one or more of the initiatives which have been given the highest priority, to the extent permitted by the resources which are available. Thus, the entity might begin by carrying out the three highest-priority initiatives 121, 122 and 123. Upon completion of those initiatives, and if resources were still available, the entity might begin implementation of one or more of the next-highest priority initiatives, which would be initiatives 124, 125, and so forth. Consequently, taking into account the implementation of at least some of the initiatives, it will be recognized that the method has a practical application which produces a useful, concrete and tangible result with real world value.

The present invention provides a number of technical advantages. One such technical advantage results from the provision of a process for efficiently and effectively identifying information-based “digital economy” innovation initiatives that improve the value which an entity provides to its customers. One type of initiative involves technology innovation. This could involve the effectiveness and/or efficiency of basic information capture, information processing, and/or information dissemination techniques that are supported by information technology. It can also involve the utilization of new information technologies, in ways that better utilize the capabilities of these new technologies.

Another type of initiative involves process innovation. This can involve the improvement of processes within which information is used, and a continuing shift in the way work is done from a physical context to a virtual context. New processes can be virtualized, and the speed or convenience of existing processes can be improved.

Yet another type of initiative involves offering innovation. This could include an increase in the value of services provided to customers, either by offering new information-based offerings, or by improving the information content of existing offerings. On a general level, this can viewed as increasing the richness of offerings through the use of information technology.

Still another type of initiative involves business model innovation. This can involve shifting the boundary of an enterprise, for example by partnering or outsourcing in order to share risk and/to shift investment costs.

Another advantage of the invention relates to an approach in which a workspace is divided into sections that respectively correspond to different categories. A plurality of ideas are each placed on the workspace within the section thereof corresponding to the category most relevant to that idea, and at a location in the section reflecting the relationship of the idea to other categories. In one specific approach, the workspace can have four sections respectively corresponding to the four above-discussed categories of technology innovation, process innovation, offering innovation, and business model innovation.

As to a different aspect of the invention, the use of the workspace can be implemented in the form of an exercise conducted by participants at a seminar or workshop. Still another aspect of the invention can involve the identification of initiatives which include one or more ideas that have been placed within the workspace. Another advantage relates to the provision of a technique for prioritizing the initiatives, so that the entity which is the focus of the analysis will begin implementation of the initiatives with a subset of the initiatives that should be most beneficial to the entity.

Although one embodiment has been illustrated and described in detail, it will be understood that various changes and alternatives are possible without departing from the spirit and scope of the present invention, as defined by the following claims.

What is claimed is:

1. A method, comprising the steps of:
generating a plurality of ideas;
providing a workspace which is divided into a plurality of sections that each correspond to a respective one of a plurality of different categories;
assigning each said idea to a respective said category to which that idea is perceived to be most relevant;
associating each said idea with a respective one of a plurality of physical identifiers;
positioning the identifier associated with each idea within the section of said workspace which corresponds to the assigned category for that idea, at a location selected so that the physical position of the identifier in relation to other said sections is representative of the perceived relevance of the associated idea to the respective categories associated with those other sections;
classifying said identifiers into at least one initiative, where each said initiative includes at least one said identifier;
subdividing said workspace into a plurality of priority regions;
assigning an order of prioritization to said priority regions; and
assigning priorities to said initiatives as a function of the physical location of each said initiative with respect to said priority regions.

2. A method according to claim 1, wherein said step of classifying said identifiers includes the step of configuring each said initiative that encompasses multiple said identifiers to include a subset of said identifiers which are positioned relatively close to each other in said workspace and for which the associated ideas are all perceived to be closely related.

3. A method according to claim 2, wherein said ideas relate to ways to improve what an entity provides to its customers;
wherein said configuring step includes the step of providing along two sides of said workspace respective first and second axes which are approximately perpendicular, said first axis representing an increasing degree of cost reduction, and said second axis representing an increasing degree of effectiveness of the entity in carrying out a mission; and
wherein said step of assigning an order of prioritization to said priority regions includes the steps of identifying a first point along said first axis which is representative of the importance to said entity of cost reduction, identifying a second point along said second axis which is representative of the importance to said entity of increasing the effectiveness of said mission, identifying within said workspace a third point which corresponds to said first and second points, and defining said order of prioritization of said regions as a function of the location of said third point within said workspace.

4. A method according to claim 1, including the step of configuring said workspace to include a generally planar portion having said sections therein.

5. A method according to claim 4, wherein said configuring step includes the step of providing within said portion of said workspace four of said sections which form a two-by-two matrix, where a first axis along one side of said matrix represents an increasing reach of operations of an entity from current operations to virtual operations, and a second axis extending along a further side of said matrix generally perpendicular to said first axis represents an increasing richness of offerings of the entity from current offerings to digital offerings.

6. A method according to claim 4, wherein said step of configuring said workspace includes the steps of:
configuring said portion thereof to be approximately rectangular; and
configuring each of said sections to be approximately rectangular and to be of approximately equal size.

7. A method according to claim 1, wherein said step of generating said ideas is carried out in a manner so that said ideas include ideas relating to ways in which a business entity can improve its business position utilizing characteristics of an information-based economy.

8. A method according to claim 1, including after said step of assigning priorities to said initiatives the further step of implementing at least one of said initiatives in an order corresponding to said assigned priorities

9. An apparatus, comprising:
a workspace divided into a plurality of sections that each correspond to a respective one of a plurality of different categories, and separately divided into a plurality of priority regions which have an order of prioritization;
a plurality of identifiers, said identifiers each being associated with a respective one of a plurality of ideas that are each assigned to one of a plurality of categories, and said identifiers each being positioned within a respective said section of said workspace which corresponds to the assigned category for the idea associated with that identifier, at a location selected so that the physical position of each identifier in relation to other said sections of said workspace is representative of a perceived relevance of the associated idea to the respective categories associated with those other sections; and
a plurality of indicators within said workspace which each represent a respective initiative and which each include at least one said identifier, said initiatives being prioritized as a function of the physical location of each said initiative with respect to said priority regions.

10. An apparatus according to claim 9, wherein each said identifier includes a self-adhesive sheet which has indicia thereon representing the associated idea, and which is removably coupled to said workspace by the adhesive material thereon.

11. An apparatus according to claim 9, wherein said workspace is subdivided into four sections arranged to form a two-by-two matrix, said matrix having along one side thereof a first axis representing an increasing reach of operations of an entity from current operations to virtual operations, and having along another side thereof a second axis extending generally perpendicular to said first axis and representing an increasing richness of offerings of the entity from current offerings to virtual offerings.

12. An apparatus according to claim 11,
wherein said workspace is approximately rectangular; and
wherein said sections thereof are of approximately the same size and are each approximately rectangular.

13. An apparatus according to claim 9, wherein each said initiative which encompasses more than one said identifier includes a subset of said identifiers which are positioned relatively close to each other within said workspace and for which the associated ideas are all perceived to be closely related.

14. An apparatus according to claim 13,
wherein said ideas relate to ways to improve what an entity provides to its customers;
wherein said workspace has along two sides thereof respective first and second axes which are approximately perpendicular, said first axis representing an increasing reach of operations of said entity from current operations to virtual operations, and said second axis representing an increasing richness of offerings of the entity from current offerings to virtual offerings; and
wherein said order of prioritization of said priority regions is a function of the location within said workspace of a first point that corresponds to second and third points respectively located along said first and second axes, said second point representing a perceived importance to said entity of increasing the richness of its offerings, and said third point representing a perceived importance to said entity of increasing the reach of its operations.
